(19) United States
(12) Patent Application Publication
(10) Pub. No.: US 2013/0033569 A1
(43) Pub. Date: Feb. 7, 2013

(54) COMBINING A THREE-DIMENSIONAL MESSAGE WITH THREE-DIMENSIONAL VIDEO CONTENT

(71) Applicant: Dinkar N. Bhat, Princeton, NJ (US)

(72) Inventor: Dinkar N. Bhat, Princeton, NJ (US)

(73) Assignee: GENERAL INSTRUMENT CORPORATION, Horsham, PA (US)

(21) Appl. No.: 13/196,917

(22) Filed: Aug. 3, 2011

(51) Int. Cl. H04N 13/00

(52) U.S. Cl. 348/43; 348/E13.001

(57) ABSTRACT

A 3D “pop-up” message is presented to users on a 3D television screen. The 3D message is formatted in such a way that it can be combined, in a post-production environment, with 3D video content. A “message mediator” receives both 3D video content and the 3D message. It also receives information from the 3D content provider about where and when within the 3D content to display the 3D message. The message mediator uses this information to combine the 3D message with the 3D video content and displays the result to the user. Any type of 3D message can be presented including advertisements, personal messages, public-service messages, reminders, and social-networking updates. Some 3D messages can be interactive, responding to user actions. The message mediator can set the transparency and depth of the 3D message to make it more compelling (the 3D message “pops out”) or less intrusive.

### FIELD OF THE INVENTION

The present invention is related generally to television communications and, more particularly, to three-dimensional television.

### BACKGROUND OF THE INVENTION

Industry reports show (a) that viewers are spending more time than ever watching television and (b) that the average U.S. home has more televisions than people (2.86 televisions for 2.5 people in 2011). These reports lead to the conclusion that the television is one of the most pervasively visible displays in the home, from the user's perspective.

Taking advantage of this prominence of television, modern two-dimensional (“2D”) television sets (and their associated set-top boxes) are beginning to provide interactive and social applications in addition to the traditional “content-consumption” experiences (e.g., broadcast programming). For example, a television screen can show an interactive user interface overlaid onto the television's traditional streaming content, the user interface supporting an application that complements the streaming content (e.g., an interactive sports interface overlaid onto a sports network feed). In another example, the television screen becomes yet another display, in addition to the displays of home computers, smart telephones, and other user devices, for Internet-based user applications. For some of these applications, content is “pulled down” from the Internet for display on the television. In more sophisticated applications, third-party web providers “push” content down to a television that supports a fully bidirectional interaction.

While there are many fewer three-dimensional (“3D”) televisions than 2D sets so far, 3D television should become more popular because it has matured to the point where it provides a compelling content-consumption experience. However, it is so difficult to combine 3D images, in a post-production environment, that 3D television has fallen behind 2D television in interactive and other messaging applications.

### BRIEF SUMMARY

The above considerations, and others, are addressed by the present invention, which can be understood by referring to the specification, drawings, and claims. According to aspects of the present invention, a 3D “pop-up” message is presented to viewers on a 3D television screen. The 3D message is formatted in such a way that it can be combined, in a post-production environment, with 3D video content.

A “message mediator” (which could be a separate device or could be an application running on, for example, a set-top box) receives both 3D video content and the 3D message. It also receives information from the 3D content provider about where and when within the 3D content to display the 3D message. The message mediator uses this information to combine the 3D message with the 3D video content and then displays the result to the viewer.

The provider of the 3D message can be different from the provider of the 3D video content.

Any type of 3D message can be presented including advertisements, personal messages, public-service messages, reminders, and social-networking updates. Some 3D messages can be interactive, responding to user actions.

In some embodiments, the message mediator receives a dense depth-map for the 3D message. The message mediator can set the transparency and depth of the 3D message to make it more compelling (the 3D message “pops out”) or less intrusive.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIG. 3 is a functional diagram of an exemplary message mediator;

FIG. 4 is a flowchart of a method for combining a 3D message with 3D video content; and

FIG. 5 is a flowchart of a method for delivering 3D video content according to aspects of the present invention.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Pop-up 3D messages are delivered to viewers. The 3D messages are overlaid onto 3D video content. The present invention enables 3D messages that can be ubiquitously displayed (i.e., they can appear on any channel for which location information has been received).

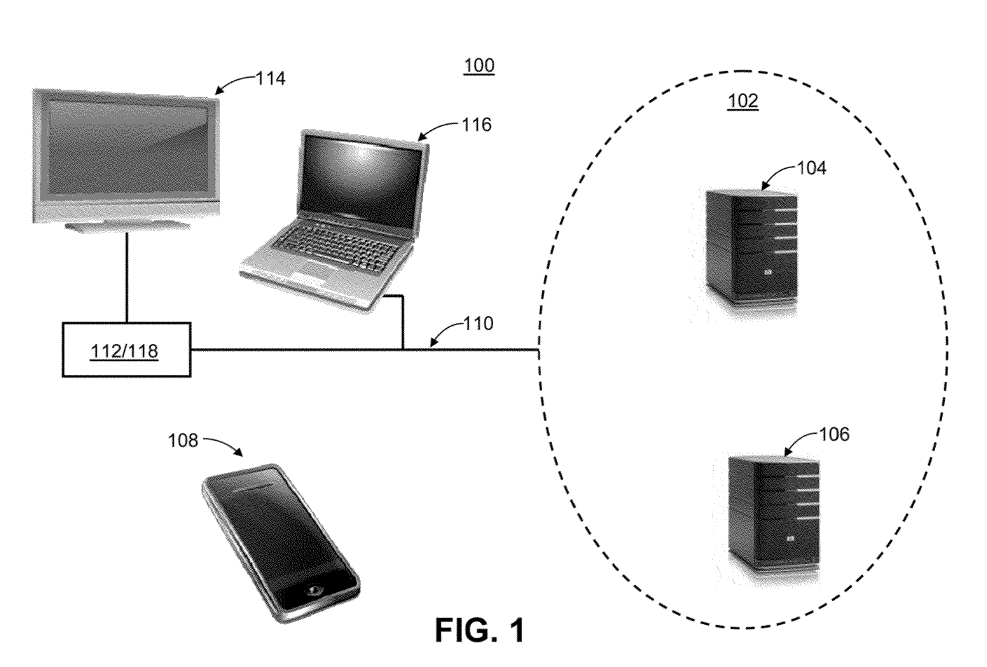

Aspects of the present invention may be practiced in the representative communications environment 100 of FIG. 1. Connected together via any or all of various known networking technologies 102 are servers such as 3D video content providers 104 and 3D message sources 106. For ease of illustration, only one of each type of server 104, 106 is shown, but multiples of each can exist and can work together, as discussed below.

The servers 104, 106 provide, via the networking technologies 102, 3D video content and 3D message services to end-user devices. One example of an end-user device is a cellular telephone 108. This telephone 108 communicates wirelessly to a wireless base station (not shown but known in the art) to access the public switched telephone network, the Internet, or other networks to access the services provided by the servers 104, 106.

Non-wireless end-user devices are supported by “wireline” network technologies (e.g., fiber, wire, and cable) 110. For example, a set-top box 112 generally receives television programming from various 3D channel providers 104 and provides a user interface (e.g., an interactive program guide) for selecting and viewing content from the cable provider. A digital video recorder (not shown) can store programming for later viewing. 3D video content may be viewed on a 3D television monitor 114 (often with the aid of 3D glasses, not shown). In some situations, a laptop computer 116 accesses web-based services either wirelessly or via the wireline network 110. A home gateway, kiosk, digital sign, or media-restreaming device (not shown) are other possible end-user devices.

(A media-restreaming device transfers content between disparate types of networks. For example, it receives content from a cable system 110 and then transmits that content over a local radio link such as WiFi to the cellular telephone 108. The media-restreaming device usually operates in both directions to carry messages between the networks. In some embodiments, aspects of the present invention are practiced by a media-restreaming device.)

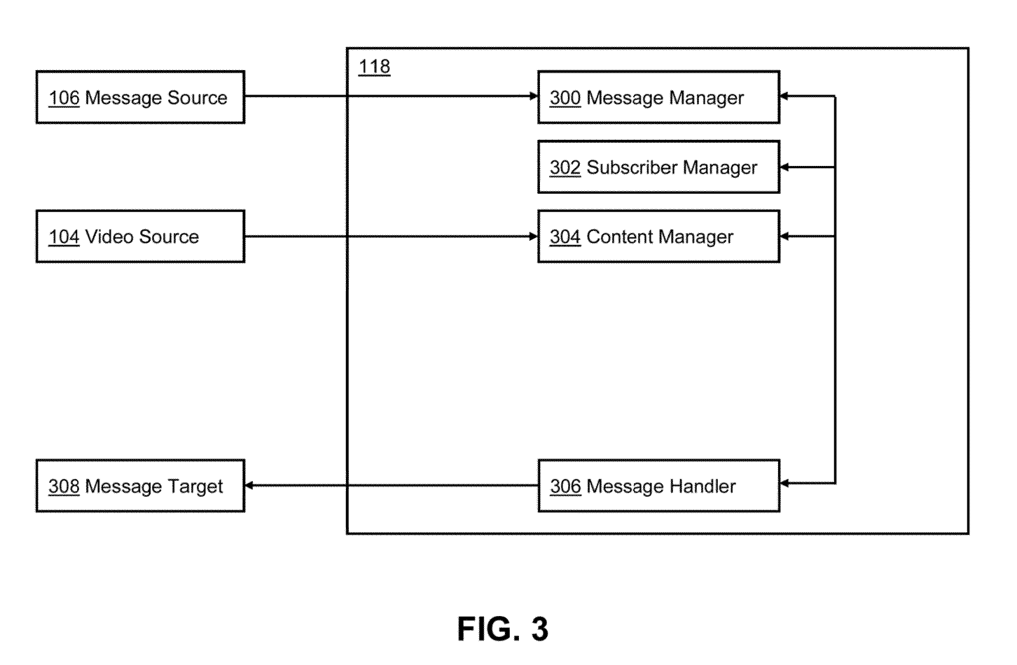

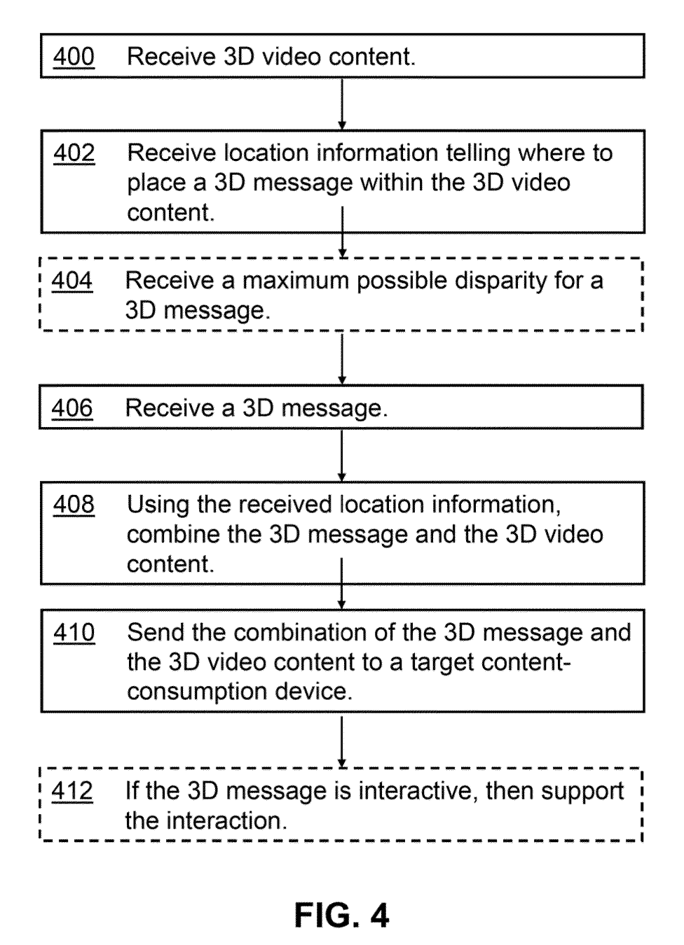

Of particular interest to the present discussion is the “message mediator” function 118. In general, the message mediator 118 receives an incoming 3D message, combines the 3D message with 3D video content, delivers the combination to an appropriate device, and handles any interactions of a user with the 3D message. (Particular aspects of this function are discussed below in conjunction with FIGS. 3 and 4.) For the sake of simplicity, the present discussion assumes that the message mediator function 118 is fully embodied on the set-top box 112, but in other embodiments the functions of the message mediator 118 can reside within the head-end of a cable provider, on web servers, on an end-user device such as the cellular telephone 108, or on some combination of these.

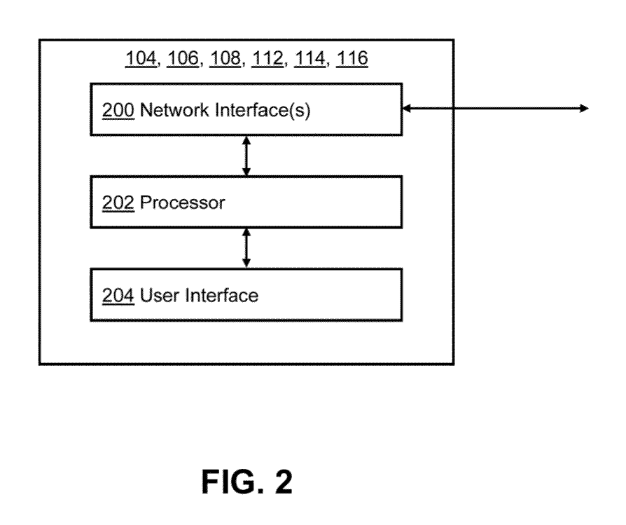

FIG. 2 shows the major components of a representative server 104, 106 or end-user device 108, 112, 114, 116. Network interfaces 200 send and receive media presentations, related information, and download requests. A processor 202 controls the operations of the device and, in particular, supports aspects of the present invention as illustrated in FIGS. 3 through 5, discussed below. The user interface 204 supports a user's (or administrator's) interactions with the device. Specific uses of these components by specific devices are discussed as appropriate below.

FIG. 3 shows various components of a relatively sophisticated exemplary message mediator function 118. In some embodiments, the message mediator 118 is simpler and is without one or more of the components in FIG. 3.

First, the 3D message source 106 can be any web-enabled, third-party application or service that generates and posts a message to the message mediator function 118. Here, “message” is meant to be very general: 3D messages can be advertisements, calendar reminders, personal messages, public-service message, social-networking update, or service messages, for example. The 3D message itself can be a descriptor (e.g., in XML) that provides such information as the intended recipient of the message, message text (e.g., a description of the message), message type (informative, interactive, or other), message context (tags that describe a category for the message), message actions (potential interactions enabled in the message), and message elements (basic user-interface elements suggested by the message source 106 for rendering this 3D message).

The message manager 300 receives the 3D message and stores it (at least until the 3D message is discarded). Several 3D messages may be pending at one time within one message mediator 118, so the 3D messages are probably each assigned a locally unique identifier and are queued for display.

In some embodiments, a subscriber manager 302 manages details of “subscribers,” that is, potential recipients of the 3D messages that are directed to this message mediator 118. These details can include email identifiers and device identifiers (e.g., an identifier of the recipient's cellular telephone 108). Thus, the subscriber manager 302 can read the intended recipient field of a 3D message descriptor and map it to a specific delivery (or “target”) device 308 to receive the 3D message.

The 3D content manager 304 manages retrieval of 3D content from sources 104 (and possibly from local storage) and playback of 3D content on subscriber devices (e.g., the television 114). Given a particular content reference request, the 3D content manager 304 retrieves the associated asset and initiates streaming onto a specific channel to the requesting subscriber device. The message handler 306 can use this channel reference to automate a channel change that allows a user to select any content associated with a 3D message as a follow-up action.

The message handler 306 coordinates the activities of the other components of FIG. 3 in order to prepare the 3D message and to handle any user responses to the 3D message. It is discussed below in conjunction with FIG. 4.

Finally, the 3D message target 308 is typically a subscriber device (e.g., the set-top box 112, television 114, or cellular telephone 108) and is the destination of the prepared 3D message. If the target device 308 can run software applications, then it may also host some of the functionality of the message mediator 118.

FIG. 4 presents an exemplary embodiment of the message handler 306 of FIG. 3. The method begins with step 400 where 3D video content is received. The content may be received from a 3D content source 104 via any communications medium including broadcast television, cable television, satellite, and the Internet. The content, though ultimately received from a 3D content source 104, may at the time of step 400 be retrieved from local storage on, for example, a digital video recorder. In some cases, the message handler 306 simultaneously receives 3D content from multiple sources.

Note that several 3D coding techniques are currently in use (including, for example, MPEG in its various versions, half-resolution side-by-side, top-bottom, and full-resolution frame interleaved). The present invention can be applied to all of these techniques.

Along with the 3D video content itself, the message handler 306 receives, in step 402, metadata about the 3D video content. The metadata tell the message handler 306 where it can overlay a 3D message onto the 3D video content. For example, the metadata can specify that the top right quadrant of the video frame from seconds 123 to 134 of the 3D content is appropriate for messaging. (That area may include only uncluttered sky, for example.) Note that it is expected that this location information is meant to be used opportunistically by the message handler 306. That is, the message handler 306 may choose to overlay a 3D message at the specified location but is not required to do so. If the 3D video content is stored for some reason (e.g., the user wishes to view the content at a later time), then most embodiments will store the accompanying metadata also.

Strictly speaking, the next step 404 is optional. Here the metadata provided with the 3D video content include, for an indicated location, a maximum possible (or permissible) disparity (used below in step 408). This value is set by the 3D content source 104 in order to allow a 3D message to merge well with the 3D video content.

Different techniques may be used to encode the metadata of steps 402 and 404. The metadata can encoded inline with the 3D video content or can be supplied in a separate file, for example. The present invention is applicable to all metadata-encoding techniques.

A 3D message is received in step 406. (Note that the steps in FIG. 4 need not occur in any particular order. In practice, the message handler 306 receives 3D messages asynchronously.) The 3D messages can come from several sources 106, and some of those 3D message sources 106 may also be 3D video content sources 104.

The 3D message may be of any type including advertisements, personal messages, public-service messages, reminders, and social-networking updates. Some 3D messages are interactive, responding to user actions.

In step 408, the message handler 306 combines the 3D message with 3D video content. In some embodiments, the message mediator 118 first determines which channel the viewer is currently watching. For example, the viewer has instructed the set-top box 112 to display broadcast television Channel 7 on the television 114. (Aspects of the present invention can apply where there is no clearly defined “channel.” Here, the role of the channel is filled by a playlist, webpage, or feed.) In some embodiments, the message mediator 118 also determines which program is currently being shown on the selected channel. When a message comes in, the message handler 306 may use the selected channel information (and program information if available) to know what 3D video content is currently being viewed. The message handler 306 then reviews the location metadata associated with that 3D video content to see if it can insert the 3D message. If it cannot, then (in general), the 3D message is saved for a later presentation.

If, on the other hand, a location is available in the current 3D video content for the 3D message, then the message handler 306 combines the 3D message with the 3D video content. The message handler 306 uses whatever information it has in order to perform the combining. If, for example, it received a maximum possible disparity in step 404, then the message handler 306 complies with that value. The 3D message may include a dense depth-map usable by the message handler 306. When the message handler 306 sets the depth of the 3D message, it may respond to aesthetic or commercial considerations. If the 3D message is an advertisement, for example, the advertiser may pay more to have the 3D advertisement “pop out” to the viewer, and the message handler 306 scales the depth map of the 3D advertisement accordingly. With enough information (e.g., a full 3D depth map), the message handler 306 can set a transparency level for the 3D message.

Note that the timing and location of the 3D message can be controlled by various rules, in addition to the location metadata received with the 3D video content. For example, a blackout condition can be applied, and 3D messages are deferred until a more appropriate time. (A 3D message may also be marked as time-critical and thus override the blackout.) If several 3D messages are available, then the message handler 306 may pick an appropriate 3D message to display by referring to the rules or to user-profile information.

In step 410, the message handler 306 sends the combination of the 3D message and 3D video content to a target content-consumption device 308. (As discussed above, the subscriber manager 302 knows which devices are associated with the intended recipient specified in the message descriptor.) If more than one target content-consumption device 308 is available, then the message handler 306 selects which such device should receive the 3D message in step 410. This decision can be based on, for example, the capability of the device's screen for displaying the 3D message, the sensitivity of the 3D message (a private issue may be best sent to a companion device 108 rather than to the television screen 114), and whether or not the 3D message has interactive elements.

If the 3D message is interactive, then in step 412, the message mediator 118 receives an action from the recipient of the 3D message and responds to that action. Exemplary actions include “save the 3D message,” “defer the 3D message,” “acknowledge the 3D message,” and “discard the 3D message.” If the action is “defer the 3D message,” then the 3D message is stored by the message manager 300.

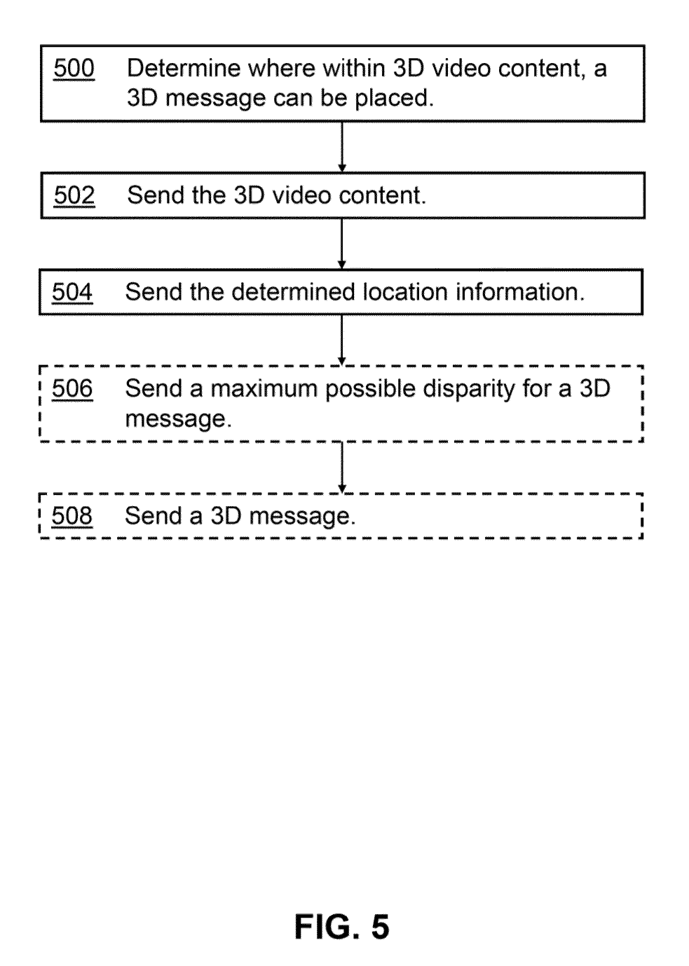

FIG. 5 presents a method for an exemplary 3D video source 104. The method begins in step 500 wherein the 3D video source 104 determines appropriate locations for placing messages in the 3D video content. In general, this is more easily accomplished by the 3D video source 104 than it would be by the message handler 306. For example, the 3D video source 104 may choose to not designate a location during an especially moving scene of the 3D video content. As mentioned above, this location information is generally advisory, and the message handler 306 can use it as its discretion.

In steps 502 and 504, the 3D video source 104 sends its 3D video content along with the determined location information.

The maximum possible disparity, for each determined location, can be sent in step 506.

The 3D video content source 104 may also be a 3D message source 106, as indicated by step 508, but need not be.

In view of the many possible embodiments to which the principles of the present invention may be applied, it should be recognized that the embodiments described herein with respect to the drawing figures are meant to be illustrative only and should not be taken as limiting the scope of the invention. For example, other 3D message types, 3D video formats, and end-user devices are contemplated that can work within the disclosed framework. Therefore, the invention as described herein contemplates all such embodiments as may come within the scope of the following claims and equivalents thereof.

We claim:

1. In a video communications environment, a method for combining a 3D message with 3D video content, the method comprising:
receiving, by a message mediator, the 3D video content;
receiving, by the message mediator, the 3D message;
determining, by the message mediator, a location for inserting the 3D message into the 3D video content, wherein determining comprises receiving location information from a source of the 3D video content;
combining, by the message mediator, the 3D message with the 3D video content at the determined location; and
sending, by the message mediator to a target content-consumption device, the combined 3D message and 3D video content.

2. The method of claim 1 wherein the message mediator is selected from the group consisting of: a server, a plurality of servers, a set-top box, a television, a personal computer, and a gaming console.

3. The method of claim 1 wherein the 3D video content is received via one of the group consisting of: a broadcast television channel, a cable television channel, a satellite-provided channel, and an Internet-provided channel.

4. The method of claim 1 wherein the 3D message is selected from the group consisting of: an advertisement, a reminder, a personal message, a public-service message, a social-networking update, and a service message.

5. The method of claim 1 wherein the 3D message and the 3D video content are received from distinct sources.

6. The method of claim 1 wherein the 3D message and the 3D video content are received from the same source.

7. The method of claim 1 wherein receiving the 3D message comprises receiving a dense depth-map for the 3D message.

8. The method of claim 1 wherein the determined location comprises an area within the 3D video content and a time associated with the 3D video content.

9. The method of claim 1 wherein combining comprises setting a depth of the 3D message.

10. The method of claim 1 wherein combining comprises setting a transparency level for at least a portion of the 3D message.

11. The method of claim 1 wherein the target content-consumption device is selected from the group consisting of: a set-top box, a television, a mobile telephone, a personal digital assistant, a personal computer, an electronic picture frame, a tablet computer, and a gaming console.

12. The method of claim 1 wherein the message mediator and the target content-consumption device are the same device.

13. The method of claim 1 wherein the message mediator and the target content-consumption device are distinct devices.

14. The method of claim 1 further comprising:
receiving, by the message mediator from a source of the 3D video content, a maximum possible disparity for the 3D message;
wherein combining comprises adhering to the received maximum possible disparity.

15. The method of claim 1 further comprising:
receiving, by the message mediator from a user of the target content-consumption device, a command associated with the 3D message; and
performing, by the message mediator, the received command;
wherein the command is selected from the group consisting of: acknowledge the 3D message, save the 3D message, defer the 3D message, and delete the 3D message.

16. A message mediator configured for combining a 3D message with 3D video content in a video communications environment, the message mediator comprising:
a transceiver configured for receiving the 3D video content and configured for receiving the 3D message; and
a processor operatively connected to the transceiver and configured for:
determining a location for inserting the 3D message into the 3D video content, wherein determining comprises receiving location information from a source of the 3D video content;
combining the 3D message with the 3D video content at the determined location; and
sending, to a target content-consumption device, the combined 3D message and 3D video content.

17. The message mediator of claim 16 wherein the message mediator is selected from the group consisting of: a server, a plurality of servers, a set-top box, a television, a personal computer, and a gaming console.

18. In a video communications environment, a method for facilitating combining a 3D message with 3D video content, the method comprising:
sending, by a 3D video source, the 3D video content;
determining, by the 3D video source, a location for inserting a 3D message into the 3D video content; and
sending, by the video source, information about the determined location.

19. The method of claim 18 wherein the 3D video content is sent via one of the group consisting of: a broadcast television channel, a cable television channel, a satellite-provided channel, and an Internet-provided channel.

20. The method of claim 18 wherein the determined location comprises an area within the 3D video content and a time associated with the 3D video content.

21. The method of claim 18 further comprising:
sending, by the 3D video source, the 3D message.

22. The method of claim 21 wherein the 3D message is selected from the group consisting of: an advertisement, a reminder, a personal message, a public-service message, a social-networking update, and a service message.

23. The method of claim 21 wherein sending the 3D message comprises sending a dense depth-map for the 3D message.

24. The method of claim 21 further comprising:
sending, by the 3D video source, a maximum possible disparity for the 3D message.

25. A 3D video source configured for facilitating combining a 3D message with 3D video content in a video communications environment, the 3D video source comprising:
a transceiver configured for sending the 3D video content; and
a processor operatively connected to the transceiver and configured for:
determining a location for inserting a 3D message into the 3D video content; and
sending, via the transceiver, information about the determined location.
